(19) United States
(12) Patent Application Publication
(10) Pub. No.: US 2013/0220447 A1
(43) Pub. Date: Aug. 29, 2013

(54) GAS BOTTLE VALVE STEM PROTECTIVE DEVICE WITH OPTIONAL FINGER GRIPS

(71) Applicant: REDERICK W. ZEYFANG, Erie, PA (US)

(72) Inventor: REDERICK W. ZEYFANG, Erie, PA (US)

(21) Appl. No.: 13/404,099

(22) Filed: Feb. 24, 2012

(51) Int. Cl. F16K 27/12

(52) U.S. Cl. 137/382

(57) ABSTRACT

A gas cylinder valve stem protective device is provided comprising a three-sided body capable of being positioned about a four-sided gas cylinder valve stem in protective relationship to three adjacent opposing faces of the valve stem, one of the sides having at least one projection extending from an interior surface thereof and configured to engage a portion of an opposing surface of the valve stem whereby the protective device is prevented from being easily removed from engagement with the valve stem. One of the opposing sides having extending therefrom a locking strip capable of being lockingly engaged with the other of the opposing sides to maintain the three-sided body in protective relationship with the valve stem. Two opposing sides of the body optionally have extending from upper portions thereof upwardly-extending grip members each configured for being gripped by a finger.

### BACKGROUND OF THE PRESENT INVENTION

The present invention is directed to a protective device for use in connection with gas bottle post valves.

Gas bottles have a variety of end uses. Such end uses range from various industrial applications, where a specified gas is required (ranging from inert gases, such as nitrogen, to oxygen gas), to medical uses where oxygen is to be administered to a patient in need of oxygen. Such bottles have a tubular valve stem extending from an end of the gas bottle for engagement with a gas delivery tube or pipe. An exemplary such valve stem is the CGA 870 medical oxygen post which is a four sided elongated valve stem having operative orifices on the side of the valve stem for engagement with an oxygen source.

Of attributes found important for protective devices used with medical gas valves, “use evidence” is particularly important because in emergency medical situations it is important for emergency personnel to be able to quickly identify which cylinder contains oxygen for use by a patient. “Use evidence” is also important to re-fillers of such compressed gas re-fillers, because full cylinders are frequently returned for credit when a full cylinder cannot be identified by content. This increases the re-filler's costs and affects the oxygen user's perception of value and quality provided by the re-filler.

An additional benefit sought for the protective device is the ability to physically protect the valve seat (the area between the bottom end of the protective device and the top of the compressed valve cylinder). Scratches and damage to the valve seat and post valve surface result in leak paths for oxygen to escape, which can result in explosion and/or fire.

The protective device must also address the needs of all who use or benefit from the protective device. Such parties include the compressed gas producers (who fill the gas bottles and initially install the protective device), the compressed gas distributors who receive the compressed gas bottles having the protective device, and the ultimate end users (home-based patients, hospitals, medical care personnel, etc.). Each level of distribution sometimes requires different attributes of the protective device. For instance, the compressed gas producer requires a protective device which is easy to install, is protective in nature, and locks into place. The distributor requires the protective device to be physically stable as installed, and not subject to being displaced from the valve stem during storage or transportation. The ultimate end users require the protective device to be physically stable as installed to provide “evidence of use” indication, and easy to remove. It would also be an advantage for the protective device to serve as means to lift and transport the gas cylinder, and/or to resist any inclination to be removed from the valve stem when grabbed by a transporter or end user.

Several prior art gas valve protective products exist, including cellulose bands and shrink wrap, and those described by U.S. Pat. No. 5,397,012, U.S. Pat. No. 3,125,242, and U.S. Pat. No. 6,003,714. Each of these products provide certain benefits, but none provide all of the desired benefits. The device of U.S. Pat. No. 5,397,012 is essentially the same as that of U.S. Pat. No. 3,125,242 with the exception that the device is cut, opened, and has a ratchet locking mechanism. The device of U.S. Pat. No. 5,397,012 appears to have been developed in an attempt to improve on the installation shortcomings of the device of U.S. Pat. No. 3,125,242 which requires tools and/or other installation aids and requires substantial downward force for installation. However, in actual practice the device of U.S. Pat. No. 5,397,012 becomes very cumbersome to install by requiring two hands to pre-fold each corner of the device before assembly.

The protective device described by U.S. Pat. No. 6,003,714 is even more cumbersome than the protective device of U.S. Pat. No. 3,125,242. The device of this patent must be wrapped around the valve stem in covering position to the gas orifice, with one free end being locked into a locking mechanism of the other free end to maintain the device in place. The fact that this protective device is able to be wrapped around the valve stem (instead of being pulled over) attempts to solve the main problem with the protective device of U.S. Pat. No. 3,125,242, which is ease of installation. However, this solution is only partially successful, as the fact that one free end must be placed into the locking mechanism at the other end and pulled tight for locking purposes requires some dexterity and extra effort. This is a significant problem when these protective devices are placed on large numbers of compressed gas cylinder valve stems in an assembly line type of environment due to the manual labor involved. This type of protective device is also difficult to secure tightly around the valve body and is prone to becoming accidentally dislodged during normal handling.

U.S. Pat. No. 5,191,992 discloses a tamperproof wrap-around seal for gas cylinders which includes a loop member adapted to be gripped by the finger of a user for transport of the gas cylinder. However, the disclosed loop is intended for a single finger, and is undesirably offset from the center of gravity of the gas cylinder.

A need accordingly exists for means by which a gas bottle may be modified to clarify whether gas has been delivered by the bottle, or whether the bottle is unused, and which does not suffer from any of the disadvantages suffered by conventional devices.

A need also exists to provide a protective device for a gas bottle valve which enables the gas bottle to be transported by gripping of the protective device.

### OBJECTS AND SUMMARY OF THE INVENTION

It is accordingly an object of the present invention to provide a protective device for use with gas bottle post valve stems.

It is further an object of the present invention to provide a protective device that will serve to seal an orifice in a post valve stem of a gas bottle.

It is further an object of the present invention to provide a protective device that can be easily placed in locking engagement with a post valve stem of a gas bottle.

It is further an object of the present invention to provide a protective device that may be easily engaged and easy to remove, while remaining in secure protective engagement with the valve stem during use.

It is yet further an object of the present invention to provide a protective device which is configured to enable the user to transport the gas cylinder by gripping of the protective device.

A gas cylinder valve stem protective device is accordingly provided comprising a three-sided body capable of being positioned about at least a portion of a four-sided gas cylinder valve stem in protective relationship to three adjacent opposing faces of the valve stem, the body comprised of two opposing sides and a side extending therebetween. One of the sides has at least one projection extending from an interior surface thereof which is configured to engage a portion of an opposing surface of the valve stem whereby the protective device is prevented from being easily removed from engagement with the valve stem. One of the opposing sides has extending therefrom a locking strip capable of being lockingly engaged with the other of the opposing sides to maintain the three-sided body in encompassing relationship with the valve stem. The device includes at least one tear strip, whereby the protective device may be removed by tearing the tear strip so as to permit disengagement and removal of the protective device from the valve stem, the tear strip defined by opposing tear lines or perforations. The two opposing sides of the body may optionally each have extending from upper extents thereof upwardly extending grip members each configured for being gripped and supporting a user's finger, whereby a gas cylinder to which the gas cylinder valve stem is attached may be lifted or supported upon finger engagement with the grip members.

### BRIEF DESCRIPTION OF THE DRAWINGS

FIG. 1 is a view in perspective of an embodiment of the protective device of the present invention with finger grips and a washer seal housing in relation to a medical gas cylinder valve stem to which it may be attached.

FIG. 2 is a view in perspective of the embodiment of the protective device of FIG. 1 after been inserted onto a medical gas cylinder valve stem.

FIG. 3 is a view in perspective of the embodiment of the protective sleeve of FIG. 1 after been inserted onto a medical gas cylinder valve stem and locked in place.

FIG. 4 is a rear view in perspective of the embodiment of the protective sleeve of FIG. 1 after been inserted onto a medical gas cylinder valve stem with a washer holder locked into place.

FIG. 5 is a longitudinal cross-sectional view of the embodiment of FIG. 4.

FIG. 6 is a lateral cross-sectional view of the embodiment of FIG. 4.

FIG. 7 is a top view of the protective device embodiment of FIG. 4.

FIG. 8 is a side view of a medical gas valve stem which may be used in conjunction with the protective device of the present invention.

FIG. 9 is a front view of the protective device of FIG. 4.

FIG. 10 is a view in perspective of another embodiment of the protective device of the present invention with finger grips without a washer seal housing.

FIG. 11 is a view in perspective of the embodiment of the protective device of FIG. 10.

FIGS. 12 and 13 depict the protective device of FIGS. 10 and 11 installed on a gas cylinder valve stem is a front view of the interior of the protective device embodiment of FIG. 1.

FIG. 14 depicts another embodiment of the protective device of the present invention with finger grips having a washer seal housing.

FIGS. 15-20 depict another embodiment of the protective device of the present invention without finger grips.

FIGS. 21-24 depict yet another embodiment of the protective device of the present invention with finger grips without a washer seal housing.

FIGS. 25-31 depict still yet another embodiment of the protective device of the present invention without finger grips and without a washer seal housing.

### DETAILED DESCRIPTION OF THE INVENTION

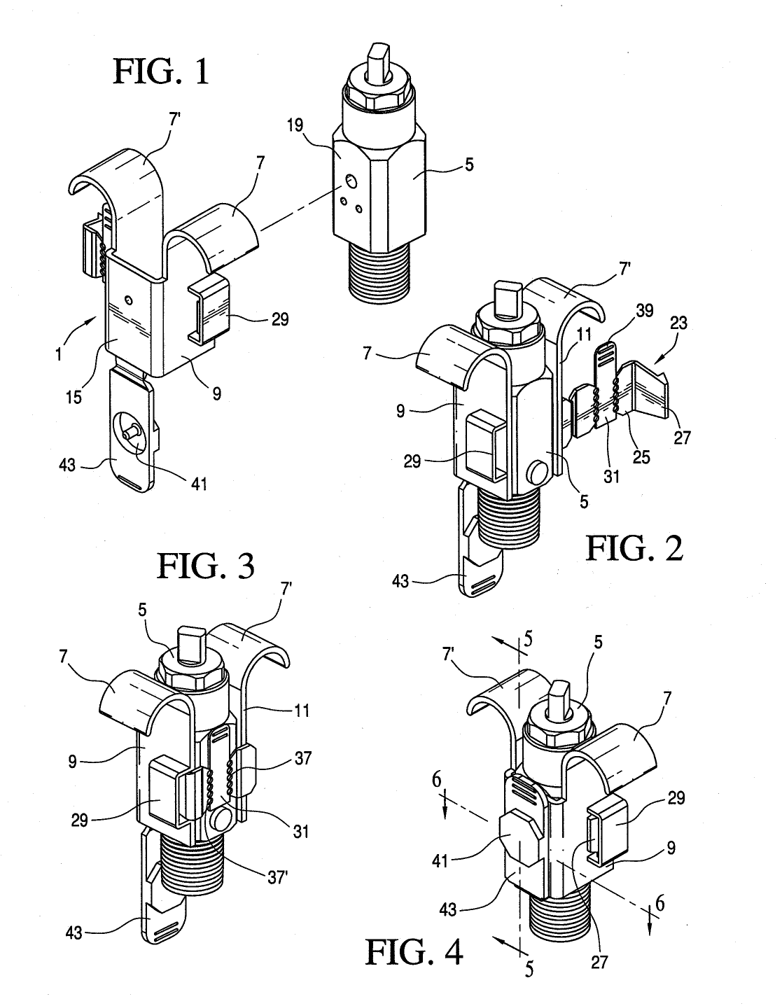

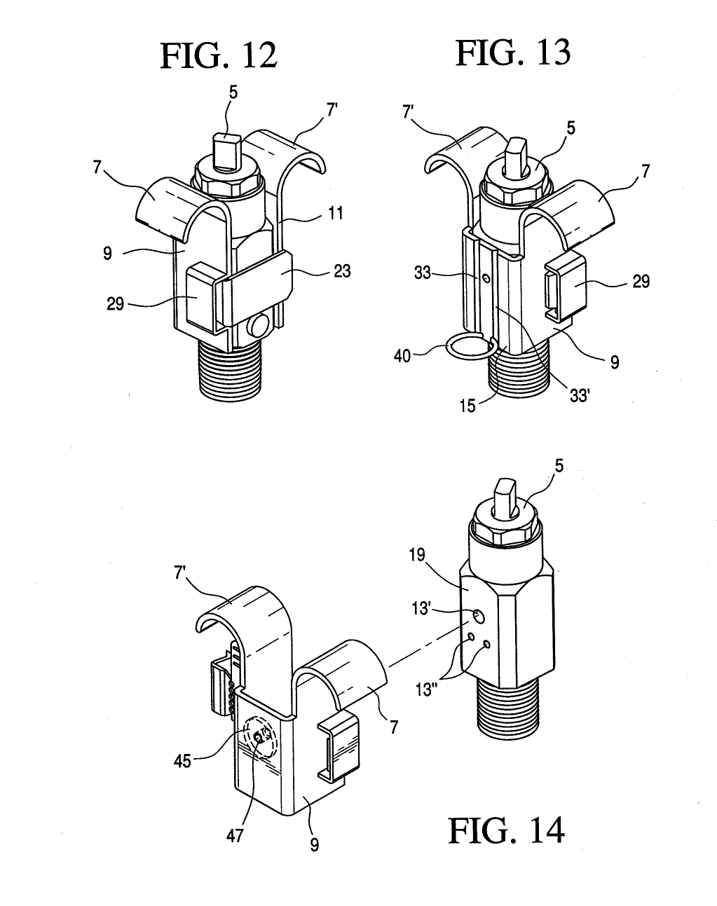

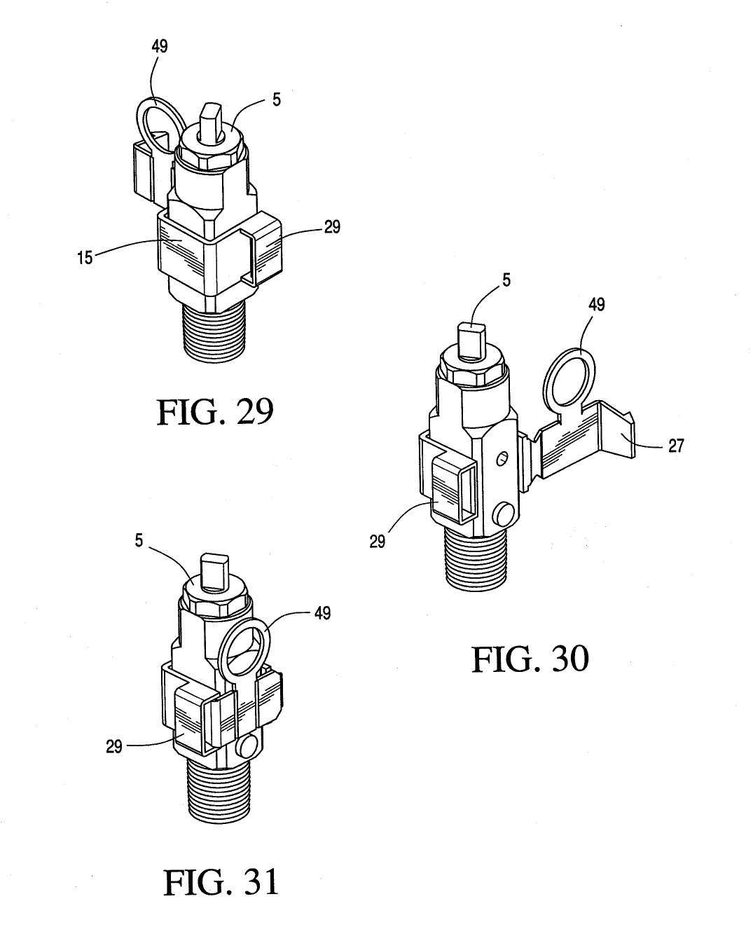

The invention will be described in connection with the FIGS. 1-31.

As shown in the Figures, the present invention comprises a protective device 1 for use in connection with valve stems 5 for gas bottles. The protective device 1 is comprised of a three-sided unitary molded body 3 of such length as to extend along at least a portion of the length of the valve stem 5.

The cross-sectional dimension of the protective device should be such that the device snugly engages the valve stem to enhance the protective aspect of the device, and particularly to enhance the engagement of the protective device with the valve stem in the manner discussed below. The three-sided body has sufficient structural integrity as to result in the desired snug fit which pushed onto the valve stem.

The protective device is open-ended at each end to enable the three-sided device to be placed onto the valve stem from the side and subsequently locked into engagement therewith.

Finger grip members 7, 7′ may optionally be present and which extend from the top or uppermost extent of the opposing sides 9, 11 of the three-sided protective device. The finger grip members 7, 7′ are configured to be easily engaged by the user's fingers to enable the device (and hence the attached gas cylinder via the valve stem 5) to be lifted and transported by the user. The upwardly-extending finger grip members are preferably arcuate in configuration so as to comfortably being capable of being gripped by the finger of a user or transporter of the device. However, the gripping surface of the finger-grip members may be any suitable configuration capable of being gripped. The finger grip members need not be present, but when present, facilitate transport of the attached compressed gas cylinder.

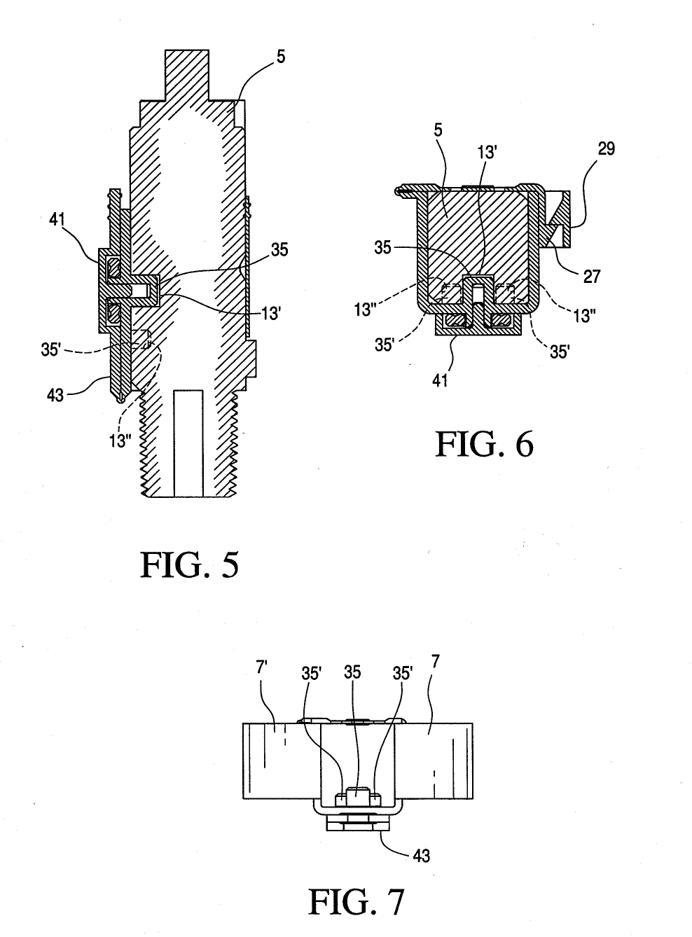

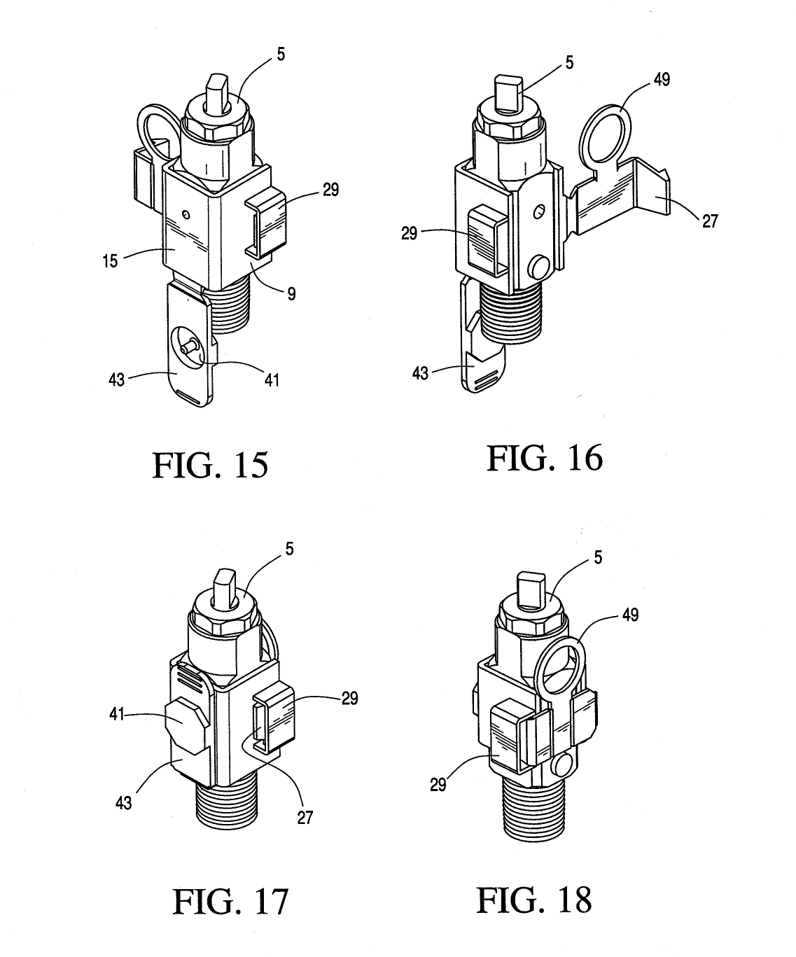

The interior surface 17 of the rear side 15 includes at least one projection/lug (and preferably multiple projections/lugs) which is configured to fit in an opening 13′, 13″ in an adjacent side 19 of the valve stem 5. The engagement of the rear side 15 in an adjacent side of the gas valve provides stability for the gas cylinder when lifted by an upward force applied to the protective device when applied to the finger grip members. When opposing side 19 is so engaged, the protective device is prevented from being removed from the valve stem upon being placed thereon due to engagement of said projections 35, 35′ with the openings 13′, 13″ in surface 19 of the gas valve stem. The locking projection 35, 35′ may be of any suitable cross-sectional configuration which is suitably configured to engage with an opposing opening(s) in the valve stem. The projections may engage one or more of the gas port 13′ or pin index holes 13″. Preferably, three projections 35, 35′ are provided which engage a portion of valve stem surface 19. The presence of three projections as shown in FIGS. 5, 6, 7, 9 and 20 is desirable when finger grip members 7, 7′ are present in order to provide enhanced engagement between the protective device and the gas cylinder valve stem. This serves to assist locking the protective device securely in place when the grip members 7, 7′ are present and used to transport the compressed gas cylinder. However, when grip members are not employed (FIGS. 15-20 and 25-31), a single projection 35 may be used as well as three projections 35, 35′.

The three-sided body of the protective device is maintained about the valve stem by locking means 23 (locking strip) extending between the opposing sides 9, 11 of the three-sided body. One of the opposing sides has extending therefrom a locking strip 25 capable of being lockingly engaged with the other of the opposing sides 9 to maintain the three-sided body in protective relationship with the valve stem. The locking strip is attached (preferably by way of a living hinge) to one of the opposing sides 11 so as to be able to extend across the opening between the free longitudinal edges of the two opposing sides 9, 11.

An exemplary embodiment for the locking means consists of a locking tab 27 at the end of the locking strip 25 which is lockingly inserted into a locking cavity 29 extending from the opposing side of the three-sided body. An alternative embodiment for the locking means includes the use of ratchet means on the locking strip which lockingly engages a locking cavity on the opposing side. The particular locking mechanism used for the locking tab is not critical to practice of the claimed invention, and one skilled in the art can readily select an appropriate mechanism. The locking means need only be able to serve as a connection between opposing sides 9, 11 and to maintain the three-sided body in protective relationship to the valve stem.

The protective device also includes a mechanism to enable the protective device to be easily removed from locking engagement with the valve stem. Desirably, a tear strip 31 (FIG. 2) is provided the tearing of which enables the protective device to be removed from the valve stem. By way of example, a tear strip may be positioned along a side of the three-sided body (FIGS. 10, 13), or within the locking means (FIGS. 2, 18, 24, 26, 31). The protective body may thus be removed by tearing the tear strip so as to permit disengagement and removal of the protective device from the valve stem.

A tear strip may extend longitudinally along at least a portion of a side 15 of the protective device (FIG. 10), and may be defined laterally by opposing tear lines 33, 33′ formed in a side of the protective device. The tear lines 33, 33′ preferably extend along the entire longitudinal extent of the protective device, but are not required to do so. The tear lines need only extend along a portion of a side of the protective device to an extent sufficient to permit disengagement of the device from the valve stem. The opposing tear lines are preferably parallel, and between which form the requisite tear strip.

In order to enhance the ease by which the tear strip may be torn and removed, a grip member 39 (FIGS. 2, 9), a grip member 40 (FIGS. 10, 13) or a grip member 49 (FIGS. 16, 18-20, 22, 24-31) is preferably provided which is attached to a portion of the tear strip to facilitate tearing of the tear strip. The configuration of the grip member is not critical. The grip member may extend either downwardly along the longitudinal axis of the protective body, or extend laterally outwardly from the body.

The tear strip may also be formed as part of the locking strip as shown in FIGS. 2, 16, 18, 19, 24, 26, 27, and 31. Again, the tear strip may be defined by tear lines 33, 33′ (FIG. 10) or by lines defined by perforations 37, 37′ (FIG. 3).

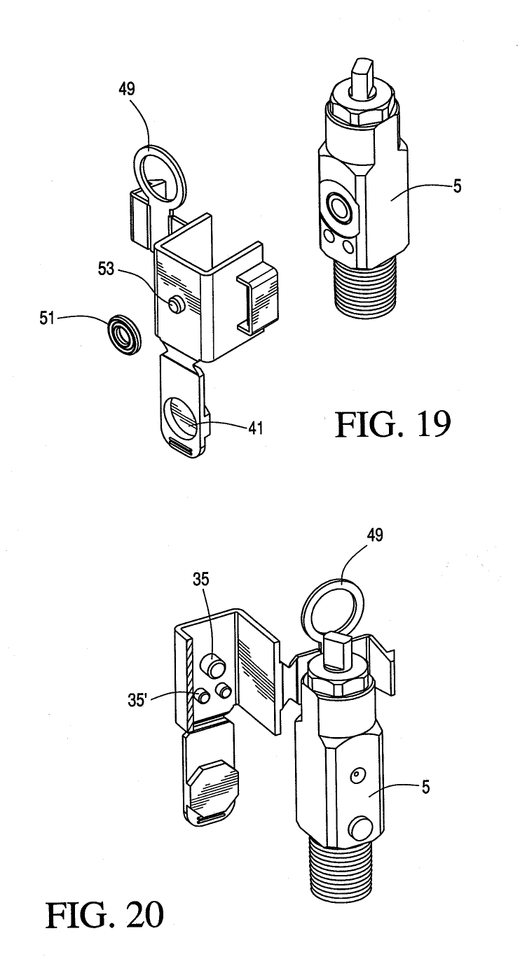

The protective device of the present invention may provide means to carry/store a washer seal 51 (FIG. 19) for use when connecting the gas bottle, in particular a washer housing.

FIGS. 1-4 depict an attached washer seal housing hingedly connected to the body 3 on tab 43 attached to a side of the body, with the washer seal housing including a cavity 41 configured to store a washer seal suitable for use with a medical gas cylinder gas valve. The tab may be locked upwardly into place against the body of the protective device to maintain the washer seal in place.

The housing may also be integrally molded into one of the walls of the protective device, with the walls of the housing 45 extending a short distance outwardly from the protective device a distance sufficient to account for the thickness of the washer seal (FIG. 14). The central hole of the washer seal may be engaged with a projection 47 extending inwardly from a wall of the housing to permit storage of the washer within the housing.

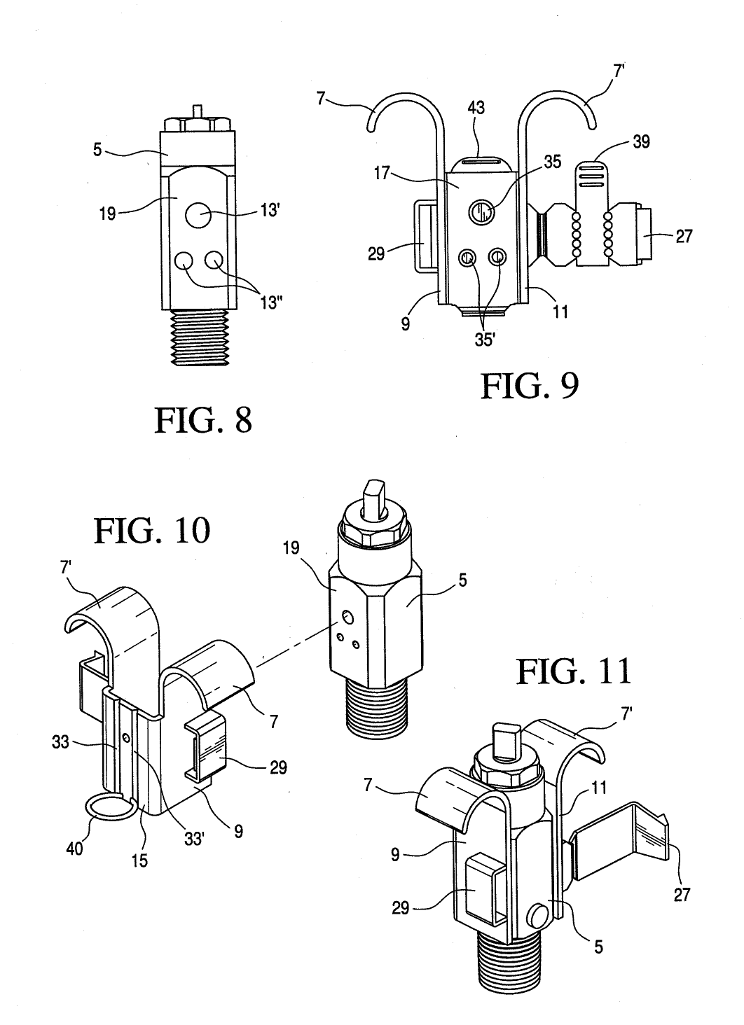

FIGS. 15-21 depict a protective device of the present invention which does not include finger grip members 7, 7′. In the depicted embodiment, a holder for a washer seal is attached to rear wall 15, having compartment 41 for the washer seal. Ring member 49 is attached to the locking strip and connected to a tear strip. FIG. 20 depicts three projections 35, 35′ configured to engage a corresponding portion of the opposing surface of the gas cylinder valve stem having gas port 13′ and pin index holes 13″ (FIG. 8). In FIG. 20 a portion of one of the opposing walls is removed to permit viewing of the projections 35, 35″.

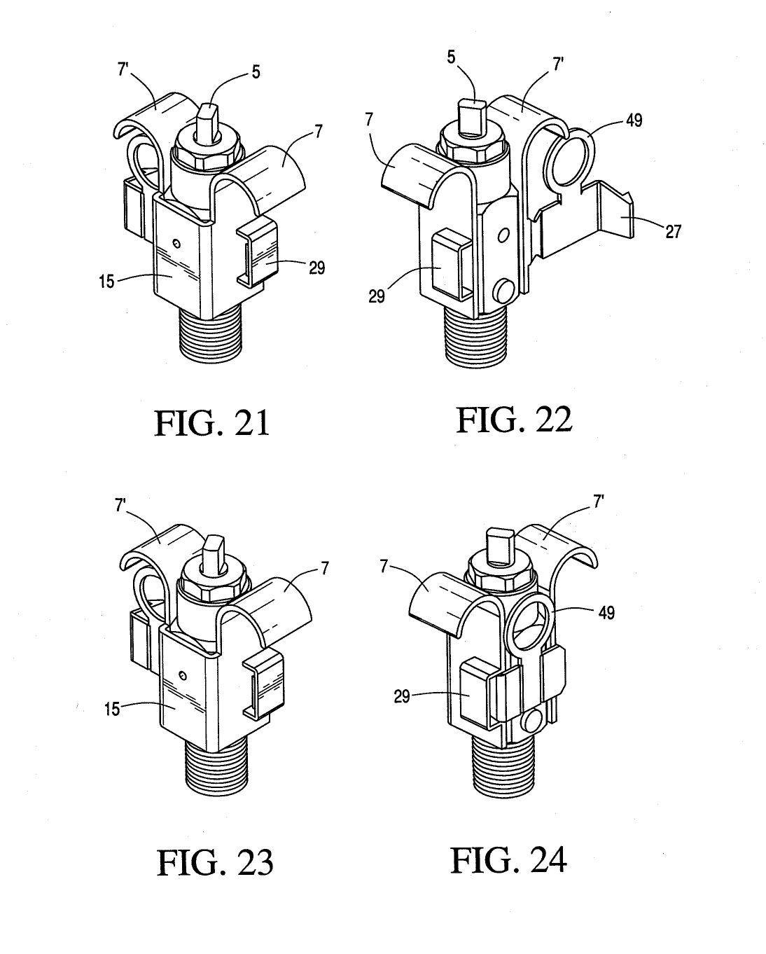

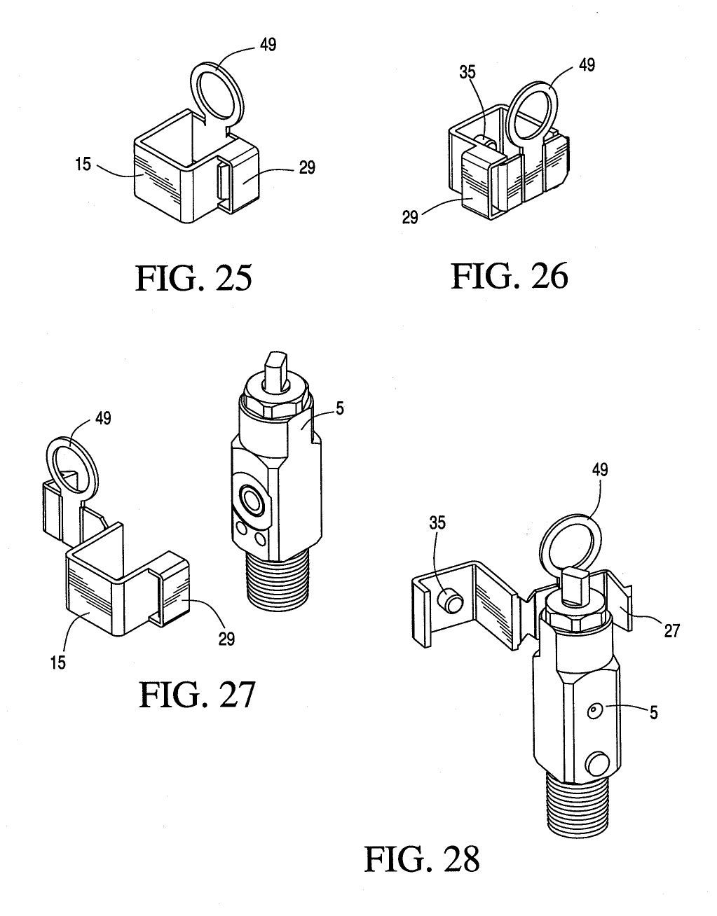

FIGS. 21-24 depict an embodiment having finger grips 7, 7′ but without a washer seal housing. FIGS. 25-31 depict an embodiment having a single projection 35 which is configured to engage the gas port in the gas cylinder valve stem, and which does not include any finger grips or a washer seal housing.

In order to install the protective device of the present invention on a gas cylinder valve stem, the device is pushed onto the valve stem in an open three-sided configuration (i.e., with the locking strip pushed to the side) as shown in FIGS. 2, 9, 11, 16, 22, and 30. Upon being pushed onto the valve stem, at least one projection on surface 17 of the protective device engages a corresponding portion of the valve stem (such as the gas port or pin index holes). Upon such engagement, the locking strap is brought around the front of the valve stem, and the locking end of the strap inserted into and locked within the locking member. In order to be removed, the grip member attached to the tear strip is torn along the tear lines, and the protective device removed from protective engagement with the valve stem. FIGS. 1-4, 10-12, 21-23, 28-30 respectively depict the installation of the protective device on a valve stem. The configuration and placement of the pin index holes on the valve stem will vary based on the type of gas in the compressed gas cylinder. The configuration and location of the pin index holes in FIGS. 1, 8, 10, 14, 19 and 27 is consistent with such placement for a gas valve stem used with a compressed oxygen cylinder.

The protective device may be formed of any suitable material which enables the protective sleeve to function in the manner discussed above. The protective device is preferably comprised of a plastic resin material suitable for molding a unitary molded body (such as by injection molding), and once formed, is sufficiently flexible to be placed over the valve stem and into engagement therewith, and sufficiently inflexible to remain engaged therewith absent removal of the tear strip.

The three sides of the protective device are molded in a manner to form a substantially inflexible U-shaped structure that can be pushed into registry with the gas valve stem.

The protective device may be comprised of a variety of plastic resin materials, such as low density polyethylene or filled flexible polyvinyl chloride. It is desirable for the body to be prepared from a plastic resin material which, once molded, is not entirely opaque, but permits viewing of the exterior of the gas valve stem. The selection of such materials and the molding method by which the device may be formed are well known to those of ordinary skill in the art.

What is claimed is:

1. A gas cylinder valve stem protective device, said device comprising a three-sided body capable of being positioned about three-sides of a four-sided gas cylinder valve stem in protective relationship to at least a portion of the faces of said three sides of said valve stem, said gas cylinder valve stem having a gas port and pin index holes, said body comprised of two opposing sides and a side extending therebetween, one of said sides having at least one projection extending from an interior surface thereof and configured to engage at least a portion of an opposing surface of said valve stem whereby said protective device is prevented from being easily removed from engagement with said valve stem, one of said opposing sides having extending therefrom a locking strip capable of being lockingly engaged with said other of said opposing sides to maintain said three-sided body in encompassing relationship with at least a portion of said valve stem, said device including at least one tear strip whereby said protective device may be removed by tearing said tear strip so as to permit disengagement and removal of said protective device from encompassing relationship to said at least a portion of said valve stem.

2. The protective device of claim 1, wherein said two opposing sides of said body each have extending from upper extents thereof upwardly-extending finger grip members each configured for being gripped and supporting a finger, whereby a gas cylinder to which said gas cylinder valve stem is attached may be lifted or supported upon finger engagement with said grip members.

3. The protective device of claim 2, wherein said upwardly-extending grip members each have an arcuate portion configured for being gripped by and supporting a finger.

4. The protective device of claim 1, wherein said tear strip is located in said locking strip.

5. The protective device of claim 1, wherein said tear strip is located in one of said sides of said three-sided body.

6. The protective device of claim 1, comprising multiple projections each configured to engage a portion of said opposing side of said valve stem upon placement of said three-sided body about said valve stem.

7. The protective device of claim 1, wherein said three-sided body comprises a unitary molded three-sided body.

8. The protective device of claim 1, wherein said tear lines extend along a longitudinal extent of said protective device.

9. The protective device of claim 1, comprised of a moldable plastic resin material.

10. The protective device of claim 1, wherein said at least one projection is configured to engage a hole in said opposing surface of said valve stem.

11. The protective device of claim 10, including one projection which is configured to engage a gas port in said opposing surface of said valve stem, and at least one projection which is configured to engage with at least one pin index hole in said opposing surface of said valve stem.

12. The protective device of claim 1, further including a housing for storage of a washer seal.

13. The protective device of claim 12, wherein said housing for storage of a washer seal comprises a hinged tab extending from an exterior of one of said sides of said body.

14. The protective device of claim 1, further including a grip member attached to said tear strip.

15. The protective device of claim 11, wherein two projections are present which are configured to engage two pin index holes in a gas valve stem.

16. The protective device of claim 15, wherein said two opposing sides of said body each have extending from upper extents thereof upwardly-extending finger grip members each configured for being gripped and supporting a finger, whereby a gas cylinder to which said gas cylinder valve stem is attached may be lifted or supported upon finger engagement with said grip members.
